(19) United States
(12) Patent Application Publication
(10) Pub. No.: US 2004/0001548 A1
(43) Pub. Date: Jan. 1, 2004

(54) Method and apparatus to facilitate variable-loss image compression for images of objects in motion

(76) Inventor: Kristen A. McIntyre, Fremont, CA (US)

Correspondence Address: PARK, VAUGHAN & FLEMING LLP, 508 SECOND STREET, SUITE 201, DAVIS, CA, 95616, US

(21) Appl. No.: 10/420,230

(22) Filed: Apr. 21, 2003

Related U.S. Application Data
(60) Provisional application No. 60/374,435, filed on Apr. 22, 2002.

(51) Int. Cl. H04N 7/12

(52) U.S. Cl. 375/240.16

(57) ABSTRACT

One embodiment of the present invention provides a system to facilitate variable-loss compression for images of objects in motion in a video system. The system operates by receiving a video stream that includes a sequence of images. The system detects motion between images within this sequence of images. Next, the system determines whether the motion exceeds a threshold value for the motion. If the motion does not exceed the threshold value for the motion, the system compresses the video stream with a compression scheme that has no significant losses. Otherwise, the system compresses the video stream with a lossy compression scheme in order to reduce the bandwidth of the video stream.

### RELATED APPLICATION

This application hereby claims priority under 35 U.S.C. §119 to U.S. Provisional Patent Application No. 60/374,435, filed on Apr. 22, 2002, entitled “Method and Apparatus to Facilitate Variable-Loss Image Compression for Images of Objects in Motion,” by inventor Kristen A. McIntyre (Attorney Docket No. SUN-P6754PSP).

### BACKGROUND

1. Field of the Invention

The present invention relates to video systems. More specifically, the present invention relates to a method and an apparatus to facilitate variable-loss image compression for images of objects in motion.

2. Related Art

Modern video systems, which transmit images from a video generating site to a video display site, typically use data compression techniques to reduce the bandwidth of the transmitted video stream. These video streams can include pictures generated by a camera, and three-dimensional renderings generated by a computer aided design (CAD) system.

Compressing a sequence of video images, which comprise the equivalent of successive frames in a digitally encoded movie, often involves a technique that compares a given frame with the immediately preceding frame. If these frames are similar, only those areas within the frames that differ are compressed and made part of the compressed data stream. Periodically, a “key-frame,” which is not a difference from the prior frame, may be sent to reduce accumulated error.

One result of this technique can be wide variation in the amount of compressed data generated per frame (or per unit time in the case of a time-sensitive movie sequence). This variation can create a condition where the amount of data per unit time can exceed the capacity of a transmission medium with fixed capacity, such as a local or wide area computer network. While the fixed bandwidth limit may not be exceeded most of the time, extreme amounts of motion will cause a spike in the required bandwidth, and will exceed the capacity of some systems. An example of this might be a movie generated through three-dimensional rendering or three-dimensional modeling. When a user manipulates a pointing device to rapidly rotate the rendering or modeling, the data requirements for sending a compressed version of this interaction using the above-described frame differencing technique will exhibit a significant spike.

What is needed is a method and an apparatus that facilitates image compression for images of objects in motion which eliminates the bandwidth problems described above.

### SUMMARY

One embodiment of the present invention provides a system to facilitate variable-loss compression for images of objects in motion in a video system. The system operates by receiving a video stream that includes a sequence of images. The system detects motion between images within this sequence, and then determines whether the motion exceeds a threshold value for the motion. If the motion does not exceed the threshold value, the system compresses the video stream with a compression scheme that has no significant losses. Otherwise, the system compresses the video stream with a lossy compression scheme in order to reduce the bandwidth of the video stream.

In one embodiment of the present invention, the sequence of images includes a stream of pictures or a stream of three-dimensional renderings.

In one embodiment of the present invention, detecting the motion includes detecting a difference between one image and the next image.

In one embodiment of the present invention, the threshold value for the motion is determined by the available bandwidth of the video system.

In one embodiment of the present invention, the first compression scheme results in a reconstructed image that does not exhibit visual degradation to the human visual system.

In one embodiment of the present invention, the second compression scheme results in a reconstructed image that exhibits blurring to the human visual system. The human visual system interprets this blurring as motion within the images.

In one embodiment of the present invention, the second compression scheme results in a reduced bandwidth that is not greater than the available bandwidth.

In one embodiment of the present invention, the system reconstructs the sequence of images at an output device. Blurring within the sequence of images on the output device is interpreted by the human visual system as motion.

### BRIEF DESCRIPTION OF THE FIGURES

FIG. 1 illustrates compressing a video stream in accordance with an embodiment of the present invention.

FIG. 2 illustrates decompressing a video stream in accordance with an embodiment of the present invention.

FIG. 3A illustrates bandwidth requirements using normal compression in accordance with an embodiment of the present invention.

FIG. 3B illustrates bandwidth requirements after using lossy compression in accordance with an embodiment of the present invention.

FIG. 4 is a flowchart illustrating the process of compressing a video stream in accordance with an embodiment of the present invention.

FIG. 5 is a flowchart illustrating the process of decompressing a video stream in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Overview

The human visual system is an imperfect system, which can tolerate a significant amount of error in images if the error is of a type that does not significantly disturb the salient elements of the image in question. The human visual system also has a limited temporal frequency response and therefore, objects in motion appear to be blurred in space. Awareness of this property is often used to illustrate motion in cartoon animation. This invention takes advantage of the deficiencies in the human visual system to mask the effects of a “lossy” digital image compression method that operates by discarding data from the image that has a minimal effect on salience.

The system described herein recognizes the conditions where the bandwidth requirement is greater than the allowed bandwidth of the video system. This excess bandwidth requirement is created when the differences from frame-to-frame are large, thus creating a spike in the required bandwidth. Upon detecting this condition, the system strips out data with high spatial frequency from the differenced images, thus reducing the required bandwidth for the compressed image. The effect of stripping out this data is a blurring of the reconstructed image only when an object is in motion.

This blurring corresponds to the motion blur commonly experienced by the human visual system when objects move rapidly in the human field-of-view. The proper visual cue for motion is the natural result of this blurring. When objects on the screen are moved rapidly, they exhibit motion blur, yet while when objects are stationary or slow-moving, they are rendered more sharply.

There are many possible ways to strip out the high frequency data to reduce bandwidth. For example, using a discrete cosine transform (DCT) with less accurate quantization, using a discrete wavelet transform (DWT) with less accurate quantization, or using component (YUV) video encoding with subsampled chroma data. A practitioner with ordinary skill in the art will be able to conceive of many more ways to strip out the high frequency data with the desired effect of blurring the image during motion, thereby reducing the amount of compressed data.

Compressing a Video Stream

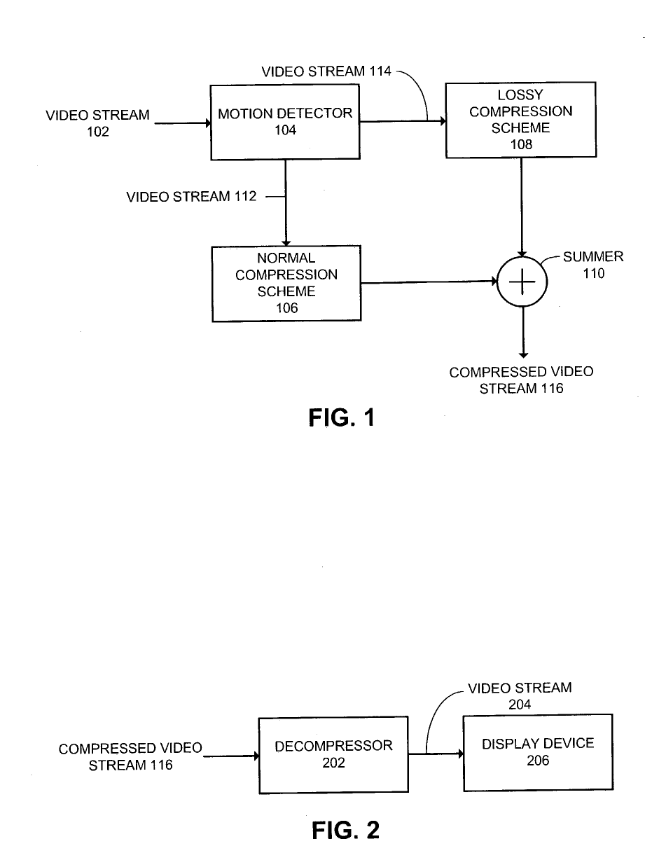

FIG. 1 illustrates compressing a video stream in accordance with an embodiment of the present invention. The system includes motion detector 104, normal compression scheme 106, lossy compression scheme 108, and summer 110. Motion detector 104 receives incoming video stream 102 and determines the amount of motion between one frame and its following frame. Any technique may be used which will determine the amount of data to be transmitted for showing the motion. A typical method includes subtracting the second frame, pixel-by-pixel, from the first frame and examining the resulting difference.

If motion detector 104 detects little or no motion between the frames, motion detector sends video stream 112 to normal compression scheme 106. Otherwise, motion detector 104 sends video stream 114 to lossy compression scheme 108.

Normal compression scheme 106 and lossy compression scheme 108 may be implemented as the same compression scheme with different parameters or may be implemented as different compression schemes. A typical example might include DWT for both schemes with some of the less important coefficients being discarded for lossy compression scheme 108. Summer 110 combines the outputs of normal compression scheme 106 and lossy compression scheme 108 to form compressed video stream 116.

Decompressing a Video Stream

FIG. 2 illustrates decompressing a video stream in accordance with an embodiment of the present invention. The decompression system includes decompressor 202 and display device 206. Decompressor 202 receives compressed video stream 116, possibly across a network connection such as the Internet. Decompressor 202 decompresses compressed video stream 116. Note that decompressor 202 includes any necessary mechanisms to determine the type of compression used by normal compression scheme 106 and lossy compression scheme 108. In the case where both normal compression scheme 106 and lossy compression scheme 108 use the same type of compression, a detecting mechanism may not be necessary. For example, if both normal compression scheme 106 and lossy compression scheme 108 use DWT with lossy compression scheme 108 discarding some of the coefficients, decompressor 202 needs to know only that DWT is being used.

Decompressor 202 supplies video stream 204 to display device 206. A user viewing display device 206 sees no degradation in the video when there is little or no motion in the objects, while the user sees blurring when there is large motion. Note, however, that the user does not perceive the blur because of the effects of the human visual system. Instead, the blur is perceived by the user as motion of the object that is in motion.

Bandwidth Requirements

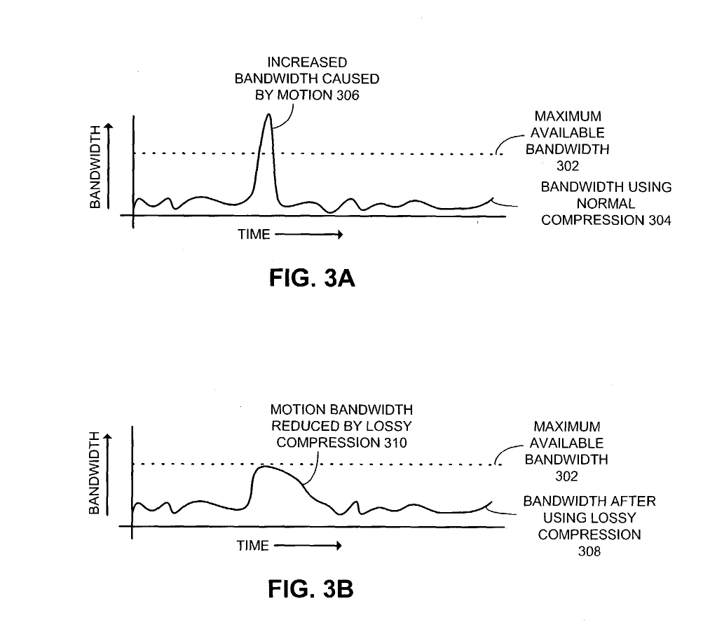

FIG. 3A illustrates bandwidth requirements using normal compression in accordance with an embodiment of the present invention. The graph shows time on the horizontal axis and bandwidth on the vertical axis. Maximum available bandwidth 302 is indicated by a dotted line, while bandwidth using normal compression 304 is shown by a solid line. When large amounts of motion between frames occur, the bandwidth can increase to be greater than maximum available bandwidth 302 as shown by increased bandwidth caused by motion 306.

FIG. 3B illustrates bandwidth requirements after using lossy compression in accordance with an embodiment of the present invention. The graph shows time on the horizontal axis and bandwidth on the vertical axis. Maximum available bandwidth 302 is indicated by a dotted line, while bandwidth after using lossy compression 308 is shown by a solid line. When large amounts of motion between frames occur, the system switches to lossy compression scheme 108. The bandwidth is then limited so that it is not greater than maximum available bandwidth 302 as shown by motion bandwidth reduced by lossy compression 310.

### Compressing a Video Stream.

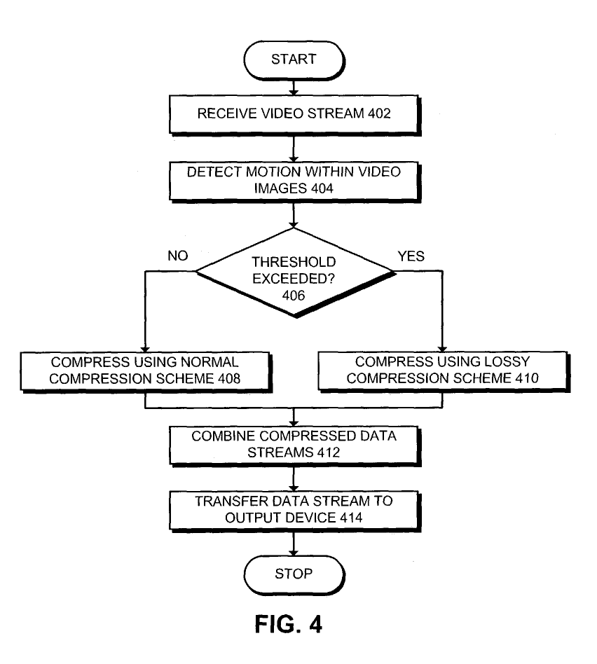

FIG. 4 is a flowchart illustrating the process of compressing a video stream in accordance with an embodiment of the present invention. The system starts when motion detector 104 receives video stream 102 (step 402). Next, motion detector 104 detects the motion within the video images (step 404). Motion detector 104 then determines if the motion causes the bandwidth threshold to be exceeded (step 406).

If the bandwidth threshold has not been exceeded, normal compression scheme 106 compresses the video stream (step 408), while lossy compression scheme 108 compresses the video stream if the bandwidth threshold has been exceeded (step 410). After compression by normal compression scheme 106 or lossy compression scheme 108, summer 110 combines the compressed video streams into compressed video stream 116 (step 412). Finally, compressed video stream 116 is transferred to an output device. Note that this output device may include a storage medium, a local display device, or a remote display device coupled to summer 110 by a network, possibly the Internet.

Decompressing a Video Stream

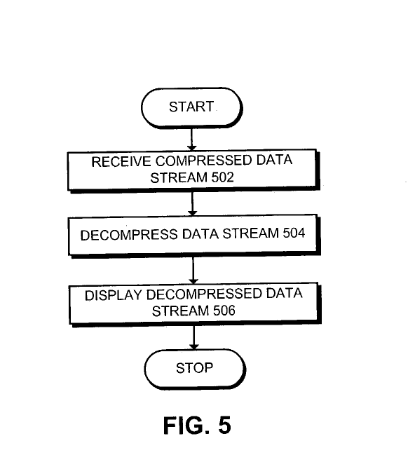

FIG. 5 is a flowchart illustrating the process of decompressing a video stream in accordance with an embodiment of the present invention. The system starts when decompressor 202 receives compressed video stream 116 (step 502). Next, decompressor 202 decompresses compressed video stream 116 creating video stream 204 (step 504). Note that decompressor 202 may need to recognize different types of compression used by normal compression scheme 106 and lossy compression scheme 108. However, if normal compression scheme 106 and lossy compression scheme 108 use the same basic compression scheme with lossy compression scheme 108 discarding some of the data, decompressor 202 may not need to be aware that compressed video stream 116 has been compressed by two different schemes. An example would be where both compression schemes use DWT and the lossy compression scheme discards some of the coefficients. Finally, display device 206 displays the decompressed data stream (step 506).

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method to facilitate variable-loss compression for images of objects in motion in a video system, comprising:
receiving a video stream, wherein the video stream includes a sequence of images;
detecting a motion between a first image and a second image within the sequence of images;
determining if the motion exceeds a threshold value for the motion;
if the motion does not exceed the threshold value for the motion, compressing the video stream with a first compression scheme; and
otherwise, compressing the video stream with a second compression scheme, wherein the second compression scheme includes a lossy compression scheme.

2. The method of claim 1, wherein the sequence of images includes one of a stream of pictures and a stream of three-dimensional renderings.

3. The method of claim 1, wherein detecting the motion includes detecting a difference between the first image and the second image.

4. The method of claim 1, wherein the threshold value for the motion is determined by an available bandwidth of the video system.

5. The method of claim 4, wherein the first compression scheme results in a reconstructed image that does not exhibit visual degradation to a human visual system.

6. The method of claim 5, wherein the second compression scheme results in the reconstructed image that exhibits blurring to the human visual system, whereby the human visual system interprets blurring as motion within an image.

7. The method of claim 6, wherein the second compression scheme results in a reduced bandwidth, whereby the reduced bandwidth is not greater than the available bandwidth.

8. The method of claim 7, further comprising reconstructing the sequence of images at an output device, whereby blurring within the sequence of images is interpreted by the human visual system as motion.

9. A computer-readable storage medium storing instructions that when executed by a computer cause the computer to perform a method to facilitate variable-loss compression for images of objects in motion in a video system, the method comprising:
receiving a video stream, wherein the video stream includes a sequence of images;
detecting a motion between a first image and a second image within the sequence of images;
determining if the motion exceeds a threshold value for the motion;
if the motion does not exceed the threshold value for the motion, compressing the video stream with a first compression scheme; and
otherwise, compressing the video stream with a second compression scheme, wherein the second compression scheme includes a lossy compression scheme.

10. The computer-readable storage medium of claim 9, wherein the sequence of images includes one of a stream of pictures and a stream of three-dimensional renderings.

11. The computer-readable storage medium of claim 9, wherein detecting the motion includes detecting a difference between the first image and the second image.

12. The computer-readable storage medium of claim 9, wherein the threshold value for the motion is determined by an available bandwidth of the video system.

13. The computer-readable storage medium of claim 12, wherein the first compression scheme results in a reconstructed image that does not exhibit visual degradation to a human visual system.

14. The computer-readable storage medium of claim 13, wherein the second compression scheme results in the reconstructed image that exhibits blurring to the human visual system, whereby the human visual system interprets blurring as motion within an image.

15. The computer-readable storage medium of claim 14, wherein the second compression scheme results in a reduced bandwidth, whereby the reduced bandwidth is not greater than the available bandwidth.

16. The computer-readable storage medium of claim 15, the method further comprising reconstructing the sequence of images at an output device, whereby blurring within the sequence of images is interpreted by the human visual system as motion.

17. An apparatus, to facilitate variable-loss compression for images of objects in motion in a video system, comprising:
a receiving mechanism that is configured to receive a video stream, wherein the video stream includes a sequence of images;
a detecting mechanism that is configured to detect a motion between a first image and a second image within the sequence of images;
a determining mechanism that is configured to determine if the motion exceeds a threshold value for the motion;
a first compressing mechanism that is configured to compress the video stream with a first compression scheme; and
a second compressing mechanism that is configured to compress the video stream with a second compression scheme, wherein the second compression scheme includes a lossy compression scheme.

18. The apparatus of claim 17, wherein the sequence of images includes one of a stream of pictures and a stream of three-dimensional renderings.

19. The apparatus of claim 17, wherein detecting the motion includes detecting a difference between the first image and the second image.

20. The apparatus of claim 17, wherein the threshold value for the motion is determined by an available bandwidth of the video system.

21. The apparatus of claim 20, wherein the first compression scheme results in a reconstructed image that does not exhibit visual degradation to a human visual system.

22. The apparatus of claim 21, wherein the second compression scheme results in the reconstructed image that exhibits blurring to the human visual system, whereby the human visual system interprets blurring as motion within an image.

23. The apparatus of claim 22, wherein the second compression scheme results in a reduced bandwidth, whereby the reduced bandwidth is not greater than the available bandwidth.

24. The apparatus of claim 23, further comprising an image reconstructing mechanism that is configured to reconstruct the sequence of images at an output device, whereby blurring within the sequence of images is interpreted by the human visual system as motion.
